(19) United States
(12) Patent Application Publication
(10) Pub. No.: US 2007/0115101 A1
(43) Pub. Date: May 24, 2007

(54) Geospatially Aware Vehicle Security

(75) Inventors: William Joseph Creekbaum, San Mateo, CA (US); David Alan Kinsfather, San Francisco, CA (US); Mahesh Malani, San Francisco, CA (US); James T. Panttaja, Healdsburg, CA (US); Steven Eftimiou, So. San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: SAPIAS, INC., San Francisco, CA (US)

(21) Appl. No.: 11/558,395

(22) Filed: Nov. 9, 2006

Related U.S. Application Data
(60) Provisional application No. 60/735,416, filed on Nov. 9, 2005.

(51) Int. Cl. B60R 25/10; B60T 8/32

(52) U.S. Cl. 340/426.22; 701/93

(57) ABSTRACT

Methods and systems provide for controlling a vehicle in conjunction with geospatial awareness. Vehicle locations are tracked and analyzed for compliance with rule sets corresponding to maintaining minimum or maximum distances from specific geographic locations or routes. A speed control command is issued to a vehicle upon violation of a rule. Speed control commands include speed reduction commands, vehicle shutdown commands, and combinations of speed reduction and vehicle shutdown commands.

### RELATED APPLICATIONS

This application claims the benefit of Provisional Patent Application Ser. No. 60/735,416, entitled “Vehicle Security,” filed Nov. 9, 2005, which is incorporated herein by reference.

### BACKGROUND

1. Field of the Invention

The present invention relates generally to vehicle security, and more specifically, to remote vehicle control informed by geospatial awareness.

2. Description of the Related Art

For individual vehicle owners and fleet owners alike, vehicle security is a rapidly growing concern. Fleet owners have even greater sensitivity to this issue, stemming from homeland security concerns, especially for trucks that carry hazardous materials and/or very valuable goods. One concern for vehicle owners is hijacking, alone, or in conjunction with threats to various structures, e.g., government buildings or landmarks. In addition, owners of vehicles that follow an authorized route, e.g., for product deliveries, require a level of security to ensure that the vehicle drivers do not substantially divert from their planned routes. A vehicle in motion presents dual concerns: how to safely bring the vehicle under control and how to prevent rogue vehicles from being used to cause intentional damage or harm to people and/or property.

Therefore, there is a need for a system and method that provides vehicle security combined with geographical awareness.

### SUMMARY

In various embodiments, the present invention provides methods and systems for controlling a vehicle in conjunction with geospatial awareness. According to the methods, vehicle locations are tracked and analyzed for compliance with rule sets corresponding to specific geographic locations. Some rules state that a vehicle maintain a minimum distance from a location, e.g., a national monument, and other rules state that a vehicle not exceed a maximum distance from a location, e.g., a point on an approved route. If one or more rules is violated, a speed control command is issued to the vehicle in violation. Speed control commands include speed reduction commands, vehicle shutdown commands, and combinations of speed reduction and vehicle shutdown commands.

The description in the specification is not all inclusive and, in particular, many additional features will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram illustrating the relationship between various entities involved in a geospatially aware security system in accordance with one embodiment of the present invention.

FIG. 2 is a flowchart illustrating a method of controlling a vehicle that violates a rule corresponding to a geographically-sensitive location according to one embodiment of the present invention.

FIG. 3 is a flowchart illustrating a method of implementing a speed control command according to one embodiment of the present invention.

FIGS. 4A and 4B illustrate examples of geo-fence regions according to various embodiments of the present invention.

FIG. 5 is a block diagram illustrating geospatially aware security provider software according to one embodiment of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

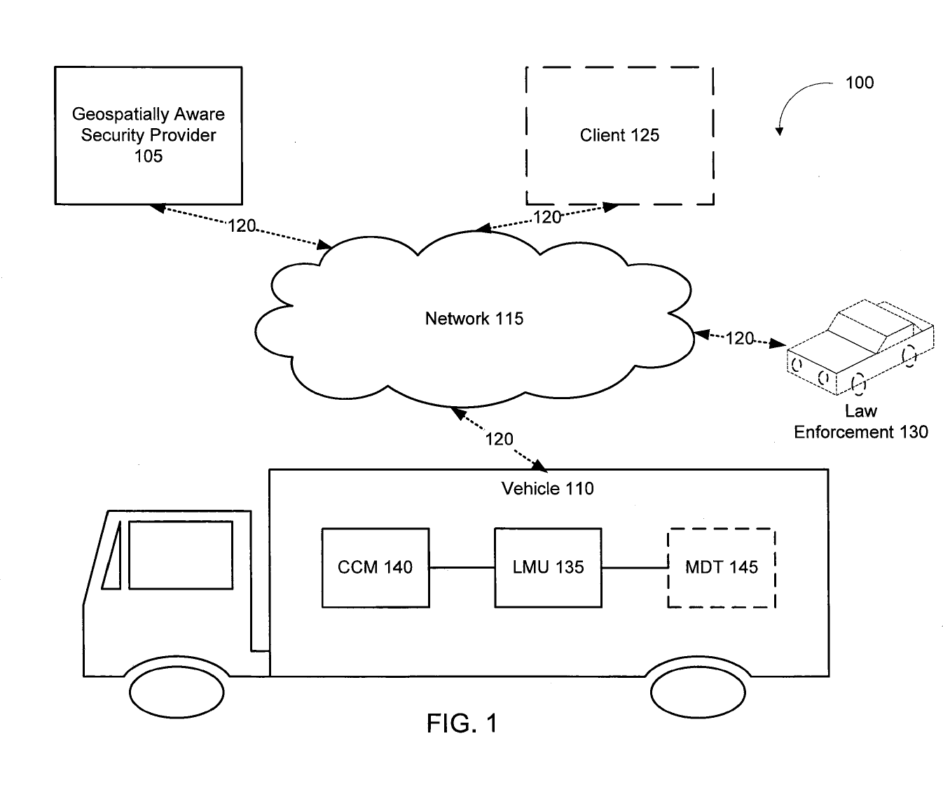

FIG. 1 is a block diagram illustrating the relationship between various entities involved in a geospatially aware security system 100 in accordance with one embodiment of the present invention.

The geospatially aware security system 100 includes at least a geospatially aware security provider 105 and at least one vehicle 110, which communicate via a network 115, e.g. a wireless network. The system 100 may include more than one vehicle 100, however, FIG. 1 shows only one vehicle 110 for clarity of explanation. The geospatially aware security provider 105 exchanges messages with the vehicle 110 and provides sophisticated data-driven message processing capabilities. The processing capabilities are utilized to provide monitoring, managing, reporting, and notifying functionality, e.g., to one or more clients 125. For example, in one embodiment the geospatially aware security provider 105 provides functionality for monitoring and managing a fleet of trucks 110 on delivery routes. The geospatially aware security provider 105 processes messages from the trucks 110 to perform functions such as determining whether trucks 110 are on schedule, whether trucks 110 have deviated from assigned routes, whether the trucks 110 are speeding, etc.

The one or more vehicles 110 exchange messages with the geospatially aware security provider 105 as described above. The vehicles 110 may be any known type of mobile transportation device. The vehicle 110 includes components to support the messaging capability, for example, a location management unit (LMU), as described in greater detail below.

The network 115 may be any type of network, including wireless networks. The network 115 may be the Internet, or other network embodiments, such as a LAN, a WAN, a MAN, a wired or wireless network, a private network, a virtual private network, or other systems allowing for data communication between two or more computing systems. The network 115 enables communication between the geospatially aware security provider 105 and the vehicle 110.

In conjunction with the various network types, the connections 120 between the entities and the network 115 may take various configurations. In one embodiment, the vehicle 110 uses conventional cellular wireless communication technologies to exchange messages with the geospatially aware security provider 105, including cellular telephone technologies using the cell control channel, code division multiple access (CDMA), general packet radio service (GPRS), satellite-based communication technologies, etc. The vehicle 110 can also use conventional wireless computer networking technologies, such as 802.11, to communicate with the geospatially aware security provider 105. In other embodiments, the vehicle 110 utilizes satellite-based communication technologies, non-cellular based radio communication technologies, and/or other technologies. Communication between the vehicle 110 and the geospatially aware security provider 105 is preferably bi-directional and the vehicle 110 and geospatially aware security provider 105 can utilize different technologies for different directions of communication.

In addition to the geospatially aware security provider 105 and vehicle(s) 110, one or more clients 125 may be included in the geospatially aware security system 100. The client 125 may be a person, computer system, application, or other entity that communicates with the geospatially aware security provider 105 to access and/or participate in the monitoring, managing, reporting, and/or notifying functionalities. The geospatially aware security provider 105 and client 125 can communicate via a variety of technologies and interfaces. For example, the client 125 can communicate with the geospatially aware security provider 105 using a telephone-based interactive voice response (IVR) interface, a web page-based interface, an email interface, data exchanged via a network connection utilizing the TCP/IP, and/or a dedicated application interface. The client 125 can utilize a variety of devices to access these interfaces, including a telephone, computer system, pager, etc. These communications can utilize conventional wired and/or wireless data and/or voice communications links. Although only one client 125 is shown in FIG. 1, embodiments of the system 100 have many clients 125.

Another optional aspect of the system 100 includes law enforcement 130. As described herein, law enforcement involvement may include the geospatially aware security provider 105 and/or client 125 notifying law enforcement of the location of the target vehicle, visual confirmation of a vehicle by law enforcement, e.g., for confirming a vehicle speed control command.

The vehicle 110 further includes a location management unit (LMU) 135, a component control module 140, and optionally a mobile data terminal 145.

The LMU 135 acts as a tracking device for the vehicle 110 according to one embodiment. The LMU 135 is a device that is physically attached to the vehicle 110, and thus the LMU 135 and the vehicle 110 are assumed to be at the same location at any given point in time, so that the location of the LMU 135 is a proxy for the location of the mobile asset itself. For this reason, this description sometimes treats the LMU 135 and the vehicle 110 as the same entity.

In general, the LMU 135 supports position determination and position reporting. In one embodiment, the LMU 135 provides position determination by having a conventional sensor adapted to use the satellite-based Global Positioning System (GPS) to determine the LMU's 135 current longitude, latitude, altitude, heading, velocity, etc. In other embodiments, an LMU 135 uses other position determination systems, such as an inertia-based tracking system, the Galileo satellite navigation system, a cellular telephone tower or television signal triangulation system, and/or an assisted GPS system such as the wide area augmentation system (WAAS). Different LMUs 135 in the system 100 can use different position determination systems.

One embodiment of the LMU 135 includes a processor and memory and is adapted to execute program code modules for generating messages. The LMU 135 is responsible for implementation of a speed control command received at the target vehicle 110.

The vehicle 110 also includes at least one component control module (CCM) 140 according to one embodiment. The CCM 140 receives the vehicle component command from the LMU 135, and is responsible for implementing the command. The CCM 140 can include any number of various vehicle controls and components.

According to one embodiment, the CCM 140 is a three-phase signal interrupt for turbo diesel engine vehicles, and the vehicle component command includes a first instruction to disrupt a turbo boost signal, a second instruction to disrupt a throttle signal, and a third instruction to disrupt the ignition.

In another embodiment, the CCM 140 is a vehicle bus, e.g., using the Society of Automotive Engineers (SAE) J1708 standard, and the vehicle component command comprises an instruction to limit target vehicle speed. In yet another embodiment, the component control module is an electronically/digitally actuated fuel valve, and the vehicle component command includes an instruction to restrict fuel flow. In this example, the electronically/digitally actuated fuel valve is electronically actuated and controlled by the LMU 135, as described herein. The process uses an RS232/485 or TTL interface to restrict the flow of fuel according to these examples.

In yet another embodiment, the CCM 140 also includes a braking system.

According to one embodiment, the CCM 140 provides for easy installation, for example, by use of a pre-made wiring harness that goes inline with the various vehicle component lines (throttle line, brake line, etc.).

The vehicle 110 optionally includes a mobile data terminal (MDT) 145 according to one embodiment. The MDT 145 is a device that allows display and input capabilities inside the vehicle 110, e.g., by the vehicle driver. The MDT 145 may have basic or advanced computing capabilities. For example, the messages received by the LMU 135, including alerts may display on the MDT 145 in some embodiments. In one embodiment, the MDT 145 requires the vehicle driver to login to the vehicle 110 before the vehicle 110 will start.

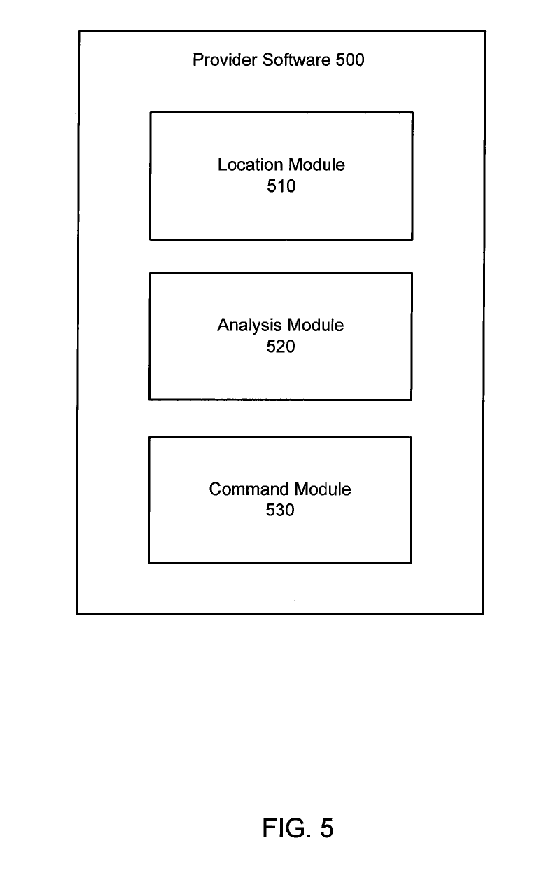

FIG. 5 is a block diagram illustrating geospatially aware security provider software 500 according to one embodiment of the present invention. The geospatially aware security provider software 500 includes a location module 510, an analysis module 520, and a command module 530.

The location module 510 enables determination of the location of a target vehicle according to one embodiment. In one embodiment, this includes receiving messages about a target vehicle.

The analysis module 520 enables analysis of the location of the target vehicle against a set of rules corresponding to allowed distances between the target vehicle and one or more geographically-sensitive locations. For example, rules may include minimum distances that a vehicle must be from locations, or may include maximum distances that a vehicle is allowed to deviate from its scheduled route/path.

The command module 530 enables issuance of a speed control command is issued to the target vehicle, responsive to a determination that a rule corresponding to a selected geographically-sensitive location has been violated by the target vehicle. The command module 530 further enables additional safeguard steps according to various embodiments, for example to confirm a vehicle for the speed control command. In one embodiment, a secured request is first initiated. The command module 530 further enables issuing a speed control command as a series of steps and/or alert levels according to one embodiment. The command module 530 further enables issuing a speed control command that is a speed reduction command, which includes a set of instructions for reducing the speed of the target vehicle, and/or a vehicle shutdown command, which includes instructions for gradually bringing the target vehicle to a complete stop.

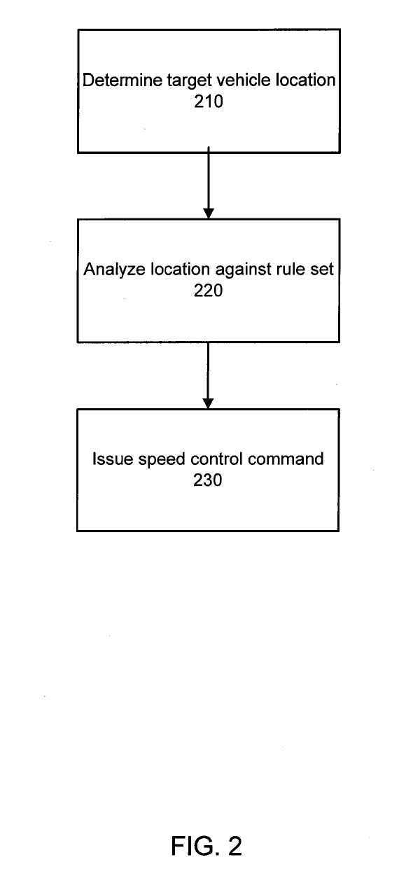

FIG. 2 is a flowchart illustrating a method of controlling a vehicle, e.g. 110, that violates a rule corresponding to a geographically-sensitive location according to one embodiment of the present invention. As described in greater detail below, a rule is violated when the condition corresponding to the rule evaluates false.

The method begins by determining 210 a location of a target vehicle 110 according to one embodiment. In one embodiment, this step includes receiving messages about a target vehicle 110. The target vehicle may be selected, for example, from a plurality of monitored vehicles. In one embodiment, the target vehicle 110 is a rogue vehicle, e.g., a vehicle that has been hijacked or otherwise has left control of its owner.

The target vehicle is tracked in conjunction with a location management unit (LMU) 135 installed in or otherwise attached to the target vehicle according to one embodiment. The LMU 135 and the target vehicle 110 are assumed to be at the same location at any given point in time, so that the location of the LMU 135 is a proxy for the location of the target vehicle 110 itself. The LMU 135 provides for position determination and position reporting to the provider 105, using GPS or other position determination systems, as described herein. In one embodiment, the LMU 135 provides position reporting using functionality for sending electronic messages reporting the LMU's position. For example, the LMU 135 may be configured to send messages at certain intervals, such as every 5 minutes or every day. In another embodiment, the LMU 135 is configured to send the messages upon the occurrence of one or more events, such as when the LMU's rate of acceleration exceeds a predetermined limit, when the LMU 135 moves a certain distance, when a vehicle 110 door is unlocked, and/or when the LMU 115 has moved within a certain distance of a predetermined or geographically-sensitive location. According to one embodiment, the LMU 135 is responsible for receiving the speed control command, translating the speed control command into a vehicle component command, transmitting the vehicle component command to a component control module 140, and monitoring the component control module for implementation of the vehicle component command, as described in greater detail below. According to another embodiment, the LMU 135 includes component control module functionality, such that it directly controls vehicle components.

The messages generated by the LMU 115 preferably contain data describing aspects of the associated target vehicle, such as location information describing the current location of the vehicle, whether it has deviated from its assigned route, whether the vehicle is speeding, etc. The LMU 135 may be used in conjunction with the MDT 145 in some embodiments, e.g., to display messages and alerts, and/or to allow the vehicle driver to login to the vehicle 110 before it will start.

Next, the location of the target vehicle 110 is analyzed 220 against a set of rules corresponding to allowed distances between the target vehicle 110 and one or more geographically-sensitive locations. The set of rules may include rules specific to the target vehicle 110, and/or may include rules generic to all monitored vehicles or monitored vehicles of the same type as the target vehicle 110. For example, rules may include minimum distances that a vehicle must be from locations such as national landmarks, government buildings, bridges, events centers, tunnels, etc., e.g., for vehicles containing hazardous materials. Also, rules may include maximum distances that a vehicle is allowed to deviate from its scheduled route/path, e.g., for vehicles transporting high-value contents. An exemplary rule is that a vehicle stay within 10 miles of its authorized path. Thus, when the corresponding condition—is the vehicle within 10 miles of its authorized path—evaluates true, i.e., the vehicle is within 10 miles of its authorized path, the rule is satisfied; when the condition evaluates false, i.e., the vehicle is more than 10 miles outside of its authorized path, the rule is violated.

Selected geographically-sensitive locations may be contained within geo-fences that define allowed distances between vehicles 110 and the various selected geographically-sensitive locations. A geo-fence is defined as a geographic region. For example, a list of geo-fences may be maintained, e.g., by the geospatially aware security provider 105. A geo-fence is preferably defined by one or more geometric constructs, such as points, lines, arcs, polygons, circles, etc. Each construct is preferably associated with a geographic location, such as a latitude and longitude, thereby establishing a geo-fence region. If a geo-fence is defined as a circle, for example, the geo-fence region preferably identifies the latitude and longitude of the center, and the distance of the radius. Similarly, if a geo-fence is defined by a polygon, the geo-fence region preferably identifies the latitudes and longitudes of the end points of each side of the polygon. A geo-fence region can be three-dimensional. If, for example, a geo-fence is defined by a sphere, the geo-fence region preferably identifies a center of the sphere at a latitude, longitude, and altitude and a radius of a given distance from the center of the sphere.

Thus, using the location information received in step 210, that location can be analyzed against the rules, including the region information, to see if any rule has been violated. In addition, the location information may be used for additional reasons over the rule analysis described below, e.g., for notifying law enforcement, e.g., 130, of the location of the target vehicle 110.

Various rules may apply, as described above, which may be satisfied or violated. For example, in one embodiment, a rule is violated by a target vehicle exceeding a maximum allowed distance from a selected geographically-sensitive location. In another embodiment, a rule violated by a target vehicle getting closer than a minimum allowed distance from a selected geographically-sensitive location.

Responsive to a determination that a rule corresponding to a selected geographically-sensitive location has been violated by the target vehicle 110, a speed control command is issued 230 to the target vehicle.

Issuing a speed control command may include additional safeguard steps, for example to confirm a vehicle for the speed control command. In one embodiment, a secured request is first initiated. The initiation process is enabled by the geospatially aware vehicle security provider 105 according to one embodiment, and the process may be controlled by the client alone or in conjunction with the provider 105. For example, the request may be secured by requiring an authenticated login by the client 125, or a user associated with the provider 105, before allowing the request to proceed. Then, the execution of the secured request may be confirmed. Various methods exist for confirming the request, e.g., to prevent unauthorized use of the system. In one embodiment, law enforcement is involved. For example, the confirmation may include visual identification by law enforcement, e.g., by a police officer following the target vehicle. In this example, the police officer provides his identification information, e.g., name and badger number, and the target vehicle identification information, e.g., license plate number or company vehicle identifier to the client 125 and/or provider 105. The information may be provided electronically via an interface in the police vehicle, via telephone, or by any other transmission means. Once the law enforcement visual is processed, the request can be executed.

According to another embodiment, the confirmation is via a manual override. For example, the manual override may be used when officer identification is not available for various reasons or is not necessary. In this example, the authorized user confirms the manual override so that the speed control command can be transmitted.

Issuing a speed control command may include a series of steps and/or alert levels according to one embodiment. For example, if a vehicle 110 is approaching a minimum allowed distance from a geographically-sensitive location, a first level alert may be issued. The alert may issue to the vehicle 110 directly, or may issue to the entity monitoring the vehicle according to various embodiments. For example, a message may issue to a client 125 according to various methods, such as email, SMS, IVR, webpage or web display, or other alert mechanism. In addition, the first level alert may include adjusting the minimum allowed distance from the geographically-sensitive location.

For example, when a rule corresponding to a geographically-sensitive location has been violated by a vehicle 110, e.g., a geo-fence boundary has been crossed, an action is triggered. Actions may be triggered by moving from inside a geo-fence region to outside a geo-fence region, or from outside a geo-fence region to inside a geo-fence region. Geo-fences may be hard geo-fences or soft geo-fences. A hard geo-fence is set and recognized by a moving device, e.g., by an LMU 135 on a vehicle 110. In this example, hard geo-fences are crossed, and an action triggered, when the device moves into or out of the geo-fence region. A soft is set and recognized on a server, e.g., at the geospatially aware security provider 105. In this example, soft geo-fences are crossed, and an action triggered, when data arrives at the server that demonstrates that the status of a device, or vehicle, has changed. Data may arrive at the server at scheduled intervals, for example, as part of the messaging of the LMU 105 as described herein. Thus, adjusting the minimum allowed distance from the geographically-sensitive location may include adjusting a geo-fence region, e.g., making the geo-fence region smaller or larger.

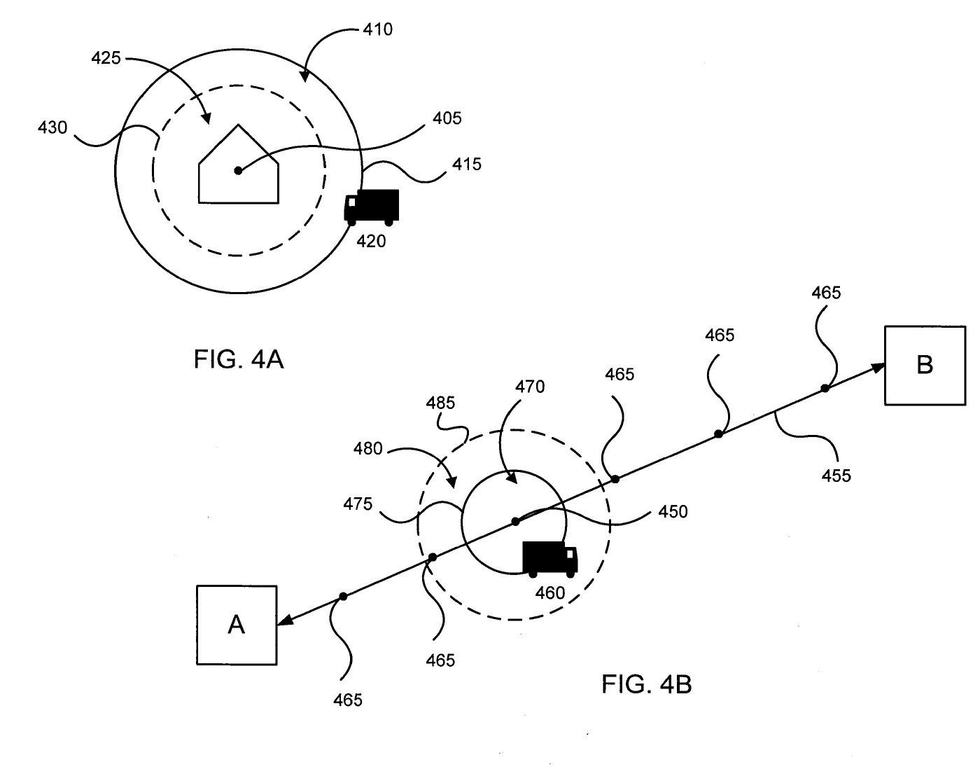

Diagrams showing examples of geo-fence regions are shown in FIGS. 4A and 4B. In FIG. 4A, a geographically-sensitive location 405, in this example a government building, is shown. Initially, a geo-fence region 410 corresponding to a boundary 415 is exists surrounding the geographically-sensitive location 405, as shown by a solid circle. In this example the geo-fence region is circular; however, geo-fences may take various other configurations as described herein. If a vehicle 420 (not shown to scale) crosses the perimeter or boundary 415 of the geo-fence 410, an alert may be issued. Also, the geo-fence boundary 415 may be adjusted according to some embodiments. For example, the boundary 415 of the geo-fence 410 may be tightened to a smaller geo-fence 425, surrounded by an adjusted boundary 430, shown by a dashed circle. If the vehicle 420 later crosses the adjusted geo-fence boundary 430, a second alert may be triggered, as described below. For example, the first geo-fence boundary 415 may have been a few miles from the geographically-sensitive location 405, and the adjusted boundary 430 may be less than one mile from the geographically-sensitive location 405, to allow for time to slow or stop the vehicle before it reaches the geographically-sensitive location 405, depending on vehicle speed.

A second example shows a geographically-sensitive location 450 that corresponds to an approved route 455 for a vehicle 460 as shown in FIG. 4B. In this example, each point 465 along the route 455 is a geographically-sensitive location at various times during the truck's journey along the route 455. As the geographically-sensitive location 450 moves along the route 455 in conjunction with vehicle movement, a geo-fence 470 bound by a geo-fence boundary 475 accompanies it, a shown by the solid circle. In this example, if the vehicle 460 leaves the geo-fence region 470, an alert may be triggered, and/or a wider geo-fence 480 and accompanying boundary 485 may be established, as shown by the dashed line.

After the first level alert is issued, if the vehicle continues on an unauthorized route, an additional alert level may apply. For example, if a vehicle is approaching an adjusted minimum allowed distance from a geographically-sensitive location, a second level alert may issue. In this example, the second level alert may include issuing the speed control command. These steps and alerts are only examples, other variations on the number and types of alerts that may be used are within the scope of the present invention.

The speed control command may be any one of various types. According to one embodiment, the speed control command is a speed reduction command, which includes a set of instructions for reducing the speed of the target vehicle 110. For example, the speed reduction command may include a maximum speed threshold. In this example, the speed of the target vehicle is reduced until the maximum speed threshold is reached, at which time the threshold speed is maintained. In addition, the instructions may include more than one threshold speed, for gradual stepwise speed reduction of the target vehicle 110, if desired. Used alone, the speed reduction command may allow for increased safety, e.g., if the vehicle is moving at excessive speed relative to its location, provide for gradual reduction of speeds in high-speed areas, e.g., on a highways, or may assist law enforcement in apprehension of the vehicle 110.

According to another embodiment, the speed control command is a vehicle shutdown command. The command includes instructions for gradually bringing the target vehicle to a complete stop. In some embodiments, the speed control command may include both speed reduction and vehicle shutdown elements, with instructions for reducing the speed of the target vehicle 110 before bringing it to a complete stop.

In yet another embodiment, the speed control command includes an instruction to shutdown the target vehicle 110 if it comes to a stop, e.g., at an intersection. This instruction may be used in combination with the speed reduction and vehicle shutdown commands, as described above for a vehicle 110 in motion.

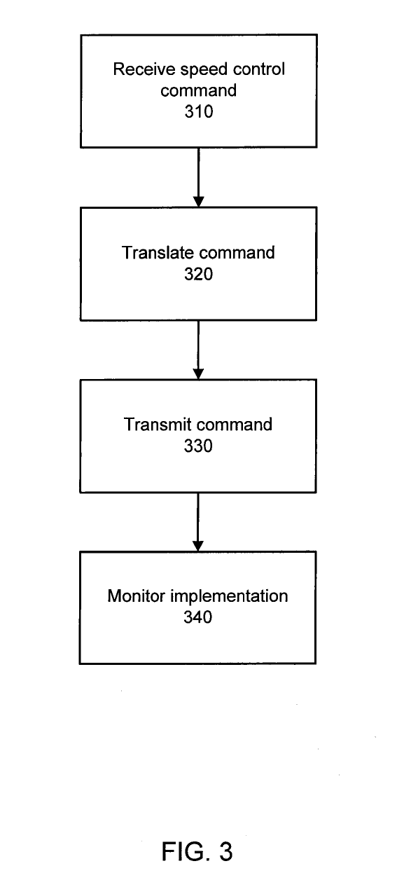

The speed control command can be implemented in various ways by the vehicle controls and components. A general method of implementing the speed control command is shown in the FIG. 3.

The implementation method begins when a speed control command is received 310 at a target vehicle 110. For example, the speed control command may be received 310 at the LMU 135 for the target vehicle 110 via wireless protocol from the geospatially aware security provider 105 or client 125 over a wireless network, e.g., 115.

Next, the speed control command is translated 320 into a vehicle component command. This aspect of the present invention allows for the message received, which may be in one format, to be processed by one or more vehicle components, which may process messages of a different format. The translation takes into consideration the nature of the component control module, and provides the necessary message translation. In one embodiment, the LMU 135 provides the translation functionality.

Once translated 320, the vehicle component command is transmitted 330 from the LMU 135 to a CCM 140 for implementation. The component control module 140 can be any number of various vehicle controls and components.

According to one embodiment, the CCM 140 is a three-phase signal interrupt for turbo diesel engine vehicles, and the vehicle component command includes a first instruction to disrupt a turbo boost signal, a second instruction to disrupt a throttle signal, and a third instruction to disrupt the ignition. In this example, the turbo boost signal first is disrupted, causing less horsepower to be generated by the engine, thus reducing the maximum speed of the vehicle. Then, the throttle input signal is disrupted, the electronic control of the turbo diesel engine will return automatically, or with an added idle switch, to an idle state. Although the vehicle will eventually come to a stop using this method, steering and braking mechanisms remain intact. Finally, the ignition is disrupted, causing the engine to turn off.

In another embodiment, the component control module 140 is a vehicle bus, e.g., using the Society of Automotive Engineers (SAE) J1708 standard, and the vehicle component command comprises an instruction to limit target vehicle speed. In yet another embodiment, the component control module 140 is electronically/digitally controlled fuel valve, and the vehicle component command includes an instruction to restrict fuel flow. In this example, the electronically/digitally controlled fuel valve is electronically actuated and controlled by a Location Management Unit (LMU), as described herein. The process uses an RS232/485 or TTL interface to restrict the flow of fuel according to two examples.

In yet another embodiment, the component control module 140 also includes a braking system, and the vehicle component command further comprises an instruction to apply the braking system.

Finally, the component control module 140 is monitored 340 for implementation of the vehicle component command. The monitoring may take place as part of the vehicle system, may be eternal to the vehicle 110, e.g., law enforcement monitoring, or a combination thereof. In one embodiment, the monitoring includes monitoring target vehicle 110 speed to confirm the target vehicle 110 has reached a maximum speed threshold.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of controlling a vehicle that violates a rule corresponding to a geographically-sensitive location, comprising:
determining a location of a target vehicle;
analyzing the location against a set of rules corresponding to allowed distances between the target vehicle and one or more geographically-sensitive locations; and
responsive to a determination that a rule corresponding to a selected geographically-sensitive location has been violated by the target vehicle, issuing a speed control command to the target vehicle.

2. The method of claim 1, wherein the selected geographically-sensitive location is contained within a geo-fence region defining the allowed distance between the target vehicle and the selected geographically-sensitive location.

3. The method of claim 2, wherein the geo-fence is set and recognized by a device associated with the target vehicle.

4. The method of claim 2, wherein the geo-fence is set and recognized on a server.

5. The method of claim 1, wherein the rule violated by the target vehicle is exceeding a maximum allowed distance from the selected geographically-sensitive location.

6. The method of claim 1, wherein the rule violated by the target vehicle is getting closer than a minimum allowed distance from the selected geographically-sensitive location.

7. The method of claim 1, further comprising:
responsive to a determination that the target vehicle is approaching a minimum allowed distance from the selected geographically-sensitive location, issuing a first level alert; and
wherein issuing the first level alert includes adjusting the minimum allowed distance.

8. The method of claim 7, further comprising:
responsive to a determination that the target vehicle is approaching the adjusted minimum allowed distance from the selected geographically-sensitive location, issuing a second level alert.

9. The method of claim 8, wherein the second level alert further comprises issuing the speed control command.

10. The method of claim 1, wherein issuing a speed control command to the target vehicle further comprises:
initiating a secured request for remote control of the target vehicle;
confirming execution of the secured request; and
transmitting the speed control command.

11. The method of claim 1, wherein the speed control command is a speed reduction command, further comprising a maximum speed threshold.

12. The method of claim 1, wherein the speed control command is a vehicle shutdown command.

13. The method of claim 12, wherein the shutdown further comprises:
disrupting turbo boost;
disrupting a throttle signal; and
disrupting ignition.

14. The method of claim 1, wherein the speed control command further comprises an instruction to shutdown the target vehicle if the target vehicle comes to a stop.

15. The method of claim 1, wherein the speed control command causes implementation of the speed control command at the target vehicle, the implementation comprising:
receiving the speed control command at the target vehicle;
translating the speed control command into a vehicle component command;
transmitting the vehicle component command to a component control module for the target vehicle; and
monitoring the component control module for implementation of the vehicle component command.

16. A system for controlling a vehicle that violates a rule corresponding to a geographically-sensitive location, comprising:
a location module for determining a location of a target vehicle;
an analysis module for analyzing the location against a set of rules corresponding to allowed distances between the target vehicle and one or more geographically-sensitive locations; and
a command module for issuing a speed control command to the target vehicle responsive to a determination that a rule corresponding to a selected geographically-sensitive location has been violated by the target vehicle.

17. The system of claim 16, wherein the selected geographically-sensitive location is contained within a geo-fence region defining the allowed distance between the target vehicle and the selected geographically-sensitive location.

18. The system of claim 16, wherein the speed control command is a speed reduction command, further comprising a maximum speed threshold.

19. The system of claim 16, wherein the speed control command is a vehicle shutdown command.

20. A method of controlling a vehicle that violates a rule corresponding to a geographically-sensitive location, comprising:
determining a location of a target vehicle;
analyzing the location against a set of rules corresponding to allowed distances between the target vehicle and one or more geographically-sensitive locations;
responsive to a determination that a rule corresponding to a selected geographically-sensitive location has been violated by the target vehicle, issuing a speed control command to the target vehicle, wherein the selected geographically-sensitive location is contained within a geo-fence region defining the allowed distance between the target vehicle and the selected geographically-sensitive location;
wherein issuing a speed control command to the target vehicle further comprises:
initiating a secured request for remote control of the target vehicle;
confirming execution of the secured request; and
transmitting the speed control command;
responsive to a determination that the target vehicle is approaching a minimum allowed distance from the selected geographically-sensitive location, issuing a first level alert, wherein issuing the first level alert includes adjusting the minimum allowed distance; and
responsive to a determination that the target vehicle is approaching the adjusted minimum allowed distance from the selected geographically-sensitive location, issuing a second level alert, wherein the second level alert further comprises issuing the speed control command.
